(19) United States
(12) Patent Application Publication
(10) Pub. No.: US 2014/0138970 A1
(43) Pub. Date: May 22, 2014

(54) ROBOT HAND AND ROBOT

(71) Applicant: Seiko Epson Corporation, Tokyo (JP)

(72) Inventors: Kenjiro MURAKAMI, Matsumoto (JP); Kazuto YOSHIMURA, Suwa (JP); Yoshinobu GOTO, Suwa (JP)

(73) Assignee: Seiko Epson Corporation, Tokyo (JP)

(21) Appl. No.: 14/165,940

(22) Filed: Jan. 28, 2014

Related U.S. Application Data
(63) Continuation of application No. 13/469,667, filed on May 11, 2012.

(30) Foreign Application Priority Data
May 13, 2011 (JP) 2011-107932

(51) Int. Cl. B25J 15/10

(52) U.S. Cl. CPC B25J 15/10
USPC 294/99.1

(57) ABSTRACT

Four fingers forming a first finger pair and a second finger pair are driven in such a way that the four fingers move closer to or away from an object simultaneously at the same speed to grip the object. This eliminates the need to drive the fingers independently, which makes it possible to simplify the structure and control of the robot hand. Moreover, one of the two fingers forming the second finger pair is a deformable finger. Therefore, even when the second finger pair grasps the object before the first finger pair grasps the object, the deformable finger is deformed, and eventually it is possible to grasp the object with the four fingers. This allows the robot hand to grip various objects even though the robot hand has a simple structure and is controlled with ease.

### CROSS-REFERENCE TO RELATED APPLICATIONS

This application is a continuation of U.S. patent application Ser. No. 13/469,667 filed on May 11, 2012. This application claims the benefit of Japanese Patent Application No. 2011-107932 filed May 13, 2011. The disclosures of the above applications are incorporated herein by reference.

### BACKGROUND

1. Technical Field

The present invention relates to a robot hand that can grasp an object.

2. Related Art

Robots that perform operations such as welding and painting have been used at industrial product manufacturing locations. Nowadays, improving production efficiency by placing robots in an assembly line for an industrial product and making the robots automatically assemble various kinds of parts into a product on the line is widespread.

The robot placed in the assembly line handles objects having various sizes and shapes. Therefore, a part (a robot hand) with which the robot grips an object is required to be highly versatile to be able to put various objects together while gripping the objects. For this reason, a robot hand having five fingers like a human hand, the robot hand that can move the fingers independently and grip an object with an appropriate grip force by detecting, by a pressure sensor provided in each finger, a reaction force which the fingers experience from the object, has been proposed (JP-A-2006-123149).

However, with the proposed existing technique, the structure and control of the robot hand become very complicated.

### SUMMARY

An advantage of some aspects of the invention is to solve at least part of the above-described problems of the exiting technique and provide a robot hand that is highly versatile and can grip various objects even though the robot hand has a simple structure and is controlled with ease.

An aspect of the invention is directed to a robot hand gripping an object with four fingers, including: a first finger pair formed of two of the four fingers; a second finger pair provided parallel to the first finger pair, the second finger pair being formed of another two of the four fingers; and a finger driving unit driving the four fingers in such a way that the four fingers can move closer to or away from the object, wherein any one of the two fingers of the second finger pair is a deformable finger that is deformed by a force smaller than a grip force required to grip the object.

With the robot hand according to the aspect of the invention, the robot hand structured as described above, it is possible to grip the object by using the first finger pair formed of two fingers and the second finger pair provided parallel to the first finger pair, the second finger pair being formed of two fingers. Here, “the second finger pair provided parallel to the first finger pair” means that the second finger pair is provided next to the first finger pair in such a way as to be directed in the same direction as the first finger pair (and therefore provided nearly parallel to the first finger pair). Moreover, one of the two fingers forming the second finger pair is a deformable finger. The deformable finger is deformed when a force smaller than a grip force required to grip the object is applied to the deformable finger, and returns to the original shape thereof when the application of the force to the deformable finger is ended. Some examples of such a deformable finger are a rubber finger that is elastically deformed and a finger that is provided with a joint having a built-in spring and can bend and stretch.

When such a robot hand according to the aspect of the invention grips the object, even when the second finger pair grasps the object (the two fingers come into contact with the object) before the first finger pair grasps the object, the deformable finger is deformed, and eventually it is possible to grasp the object with the four fingers. Moreover, even when the size of the object in a position in which the first finger pair grasps the object and the size of the object in a position in which the second finger pair grasps the object are different from each other, it is possible to eliminate the difference in size by the deformation of the deformable finger. As a result, the robot hand according to the aspect of the invention can grip various objects even though the robot hand has a simple structure and is controlled with ease.

Moreover, in the above-described robot hand according to the aspect of the invention, the finger driving unit may drive the four fingers in such a way that the four fingers move closer to or away from the object simultaneously at the same speed. This eliminates the need to drive the fingers independently and makes it possible to simplify the structure and control of the robot hand.

Furthermore, in the above-described robot hand according to the aspect of the invention, the space between the two fingers forming the second finger pair including the deformable finger may be smaller than the space between the two fingers forming the first finger pair including no deformable finger.

In this configuration, when most objects are gripped, the second finger pair first grasps an object, then the deformable finger is deformed, and the first finger pair grasps the object. This allows the robot hand to grip most objects by making the four fingers come into contact therewith, making it possible to provide a highly versatile robot hand.

Moreover, in the above-described robot hand according to the aspect of the invention, the space between the two fingers forming the second finger pair including the deformable finger may be larger than the space between the two fingers forming the first finger pair including no deformable finger.

Since the robot hand according to the aspect of the invention can move the four fingers closer to or away from an object, the robot hand can also hold, for example, an object with a hole by inserting the four fingers into the hole of the object and making the four fingers come into contact with the inner periphery of the hole. When the robot hand holds the object in this manner, the space between the second finger pair is made larger than the space between the first finger pair. By doing so, most objects are held in the following manner. The second finger pair first comes into contact with the inner periphery of the hole of an object, then the deformable finger is deformed, and the first finger pair comes into contact with the inner periphery of the object. As a result, the robot hand can grip most objects stably by making the four fingers come into contact with the inner periphery of a hole of an object.

Furthermore, the above-described robot hand according to the aspect of the invention can grip various objects even though the robot hand has a simple structure and is controlled with ease. Therefore, by creating a robot by using the robot hand according to the aspect of the invention, it is possible to create a robot that is highly versatile while having a simple structure and being controlled with ease.

### BRIEF DESCRIPTION OF THE DRAWINGS

The invention will be described with reference to the accompanying drawings, wherein like numbers reference like elements.

FIGS. 1A and 1B are explanatory diagrams showing the structure of a robot hand of an embodiment.

FIGS. 2A and 2B are explanatory diagrams showing a state in which the robot hand of the embodiment grips an object.

FIGS. 3A and 3B are explanatory diagrams showing a state in which the robot hand grips an object with a nonuniform thickness.

FIGS. 4A and 4B are explanatory diagrams showing, for reference sake, a state in which a robot hand having fingers made of metal grips an object.

FIGS. 5A and 5B are explanatory diagrams showing, for reference sake, a state in which an object is gripped by using a three-fingered robot hand.

FIGS. 6A and 6B are explanatory diagrams showing a state in which, when the robot hand of the embodiment grips an object with a nonuniform thickness, the robot hand grips the object in a thinner portion thereof with a finger pair B.

FIGS. 7A and 7B are explanatory diagrams showing the structure of a robot hand of a first modified example.

FIG. 8 is an explanatory diagram showing the structure of a robot hand of a second modified example.

FIGS. 9A and 9B are explanatory diagrams showing a state in which the robot hand of the second modified example holds an object.

FIG. 10 is an explanatory diagram showing a robot provided with the robot hand.

### DESCRIPTION OF EXEMPLARY EMBODIMENTS

Hereinafter, to clarify the subject matter of the invention, an embodiment will be described in the following order.

A. Structure of a robot hand of the embodiment

B. Gripping operation of the robot hand of the embodiment

C. Modified examples
C-1. First modified example
C-2. Second modified example

### A. Structure of a Robot Hand of the Embodiment

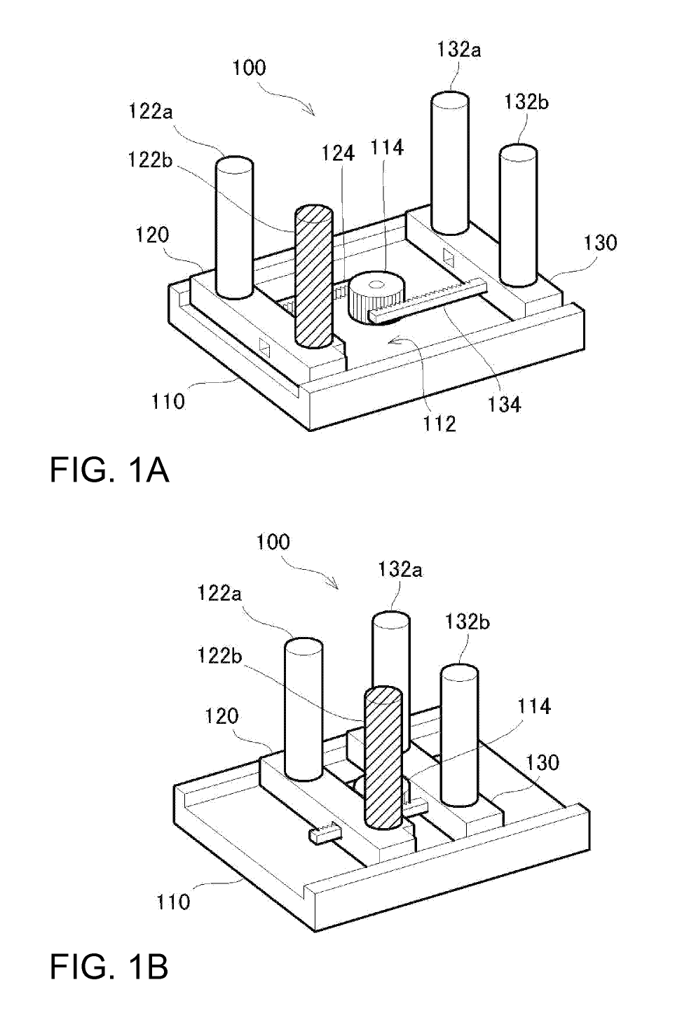

FIGS. 1A and 1B are explanatory diagrams showing the structure of a robot hand 100 of the embodiment. As shown in the drawings, the robot hand 100 of the embodiment is broadly formed of three portions. A foundation of the robot hand 100 is formed of, for example, a base 110 with a flat plate-like top surface in which a large guide groove 112 is formed, a pinion gear 114 provided roughly in the center of the guide groove 112, and an unillustrated motor for rotating the pinion gear 114. Moreover, on the right and left sides of the base 110 in the drawing, roughly rectangular parallelepiped-shaped moving members 120 and 130 are provided. On the top surface of the moving member 120, two finger members 122a and 122b are provided, and, on the top surface of the moving member 130, two finger members 132a and 132b are provided. Incidentally, in the following description, the two finger members (the finger members 122a and 132a) facing each other at the back in the drawing are sometimes referred to as a finger pair A (a first finger pair), and the two finger members (the finger members 122b and 132b) facing each other on the near side in the drawing are sometimes referred to as a finger pair B (a second finger pair).

Moreover, in the robot hand 100 of this embodiment, the two finger members (the finger members 122a and 132a) of the finger pair A are made of a material possessing high stiffness (in this embodiment, metal). On the other hand, in the finger pair B, the finger member 132b is made of a metal material, and the finger member 122b is made of a material possessing low stiffness (in this embodiment, rubber). Furthermore, the rubber finger member 122b (the deformable finger) is provided in such a way as to be slightly closer to the right in the drawing (that is, in a direction in which the rubber finger member 122b is closer to the moving member 130) than the finger member 122a provided on the same moving member 120. The reason why the finger member 122b is provided in this manner will be described later.

Both the moving member 120 and the moving member 130 are fit into the guide groove 112 of the base 110 and can slide on the base 110 from side to side in the drawing. Moreover, in the moving member 120 and the moving member 130, racks 124 and 134 are provided, respectively, and the racks 124 and 134 mesh with the pinion gear 114. Therefore, when the pinion gear 114 is rotated, the moving member 120 and the moving member 130 slide, and the space between one of the two finger pairs (the finger pairs A and B) and the space between the other of the two finger pairs vary. For example, when the pinion gear 114 is rotated in a counterclockwise direction in the drawing, the space between the finger pair A and the space between the finger pair B are increased as shown in FIG. 1A. When the pinion gear 114 is rotated in a clockwise direction, the space between the finger pair A and the space between the finger pair B are reduced as shown in FIG. 1B. As a result, the four finger members 122a, 122b, 132a, and 132b move closer to or away from an object W simultaneously at the same speed. Incidentally, the moving members 120 and 130, the racks 124 and 134, and the pinion gear 114 of this embodiment correspond to “a finger moving unit” according to the invention.

### B. Gripping Operation of the Robot Hand of the Embodiment

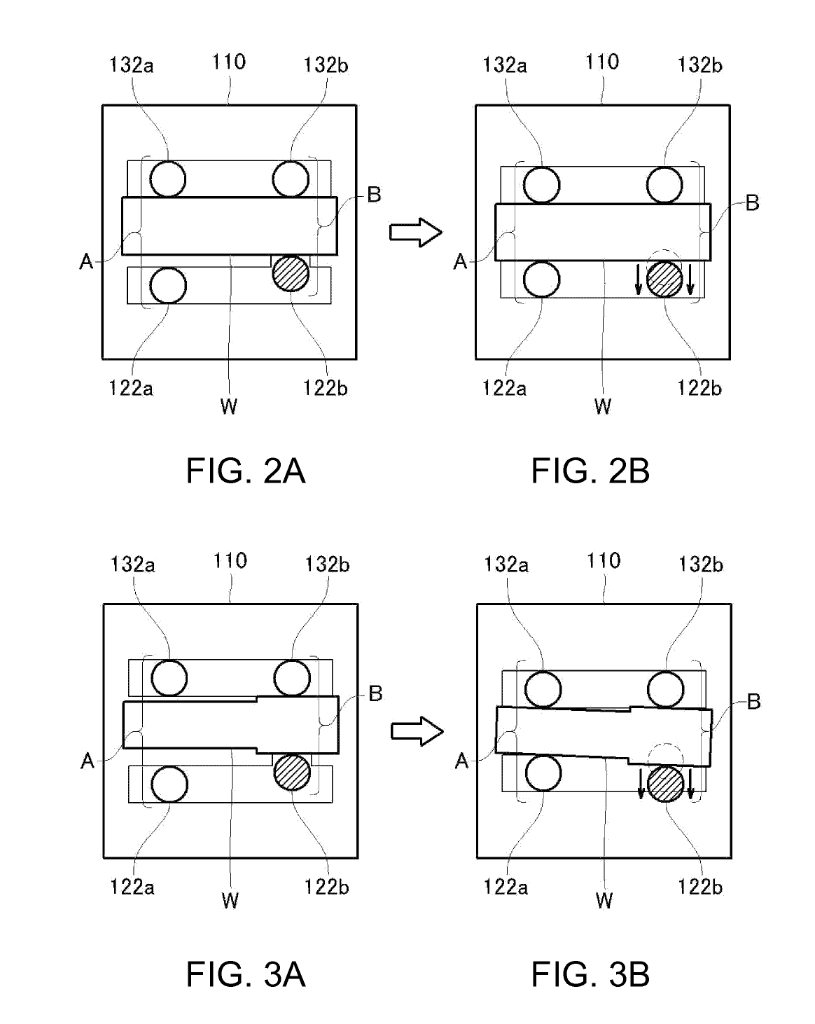

FIGS. 2A and 2B are explanatory diagrams showing a state in which the robot hand 100 of this embodiment grips an object. In FIGS. 2A and 2B, a state in which the robot hand 100 grips an object W with a uniform thickness, the state viewed from the direction of the fingertips of the robot hand 100, is shown.

To grip the object W, the pinion gear 114 is rotated to move the moving member 120 and the moving member 130 closer to the object W. As described earlier, since the finger member 122b provided on the moving member 120 is provided to be slightly closer to the moving member 130 than the finger member 122a provided on the same moving member 120, the finger pair B comes into contact with the object W before the finger pair A comes into contact with the object W as shown in FIG. 2A. The finger member 122b of the finger pair B is made of rubber and is elastically deformed by a force smaller than a force (a grip force) required to grip the object W. Therefore, when the space between the finger pair B is further reduced as compared to the state (the state shown in FIG. 2A) in which the finger pair B makes contact with the object W, the finger member 122b is deformed by the reaction force from the object W as shown in FIG. 2B, and the object W is gripped in two portions thereof by the finger pair A and the finger pair B.

FIGS. 3A and 3B are explanatory diagrams showing a state in which the robot hand 100 grips an object with a nonuniform thickness. In FIGS. 3A and 3B, a state in which the robot hand 100 grips an object W with a right portion formed to be thicker than a left portion in the drawing is shown.

To grip such an object W, the moving member 120 and the moving member 130 are also moved to closer to the object W, and the finger pair B comes into contact with the object W before the finger pair A comes into contact with the object W (see FIG. 3A). When the space between the finger pair B is further reduced, the rubber finger member 122b is elastically deformed as shown in FIG. 3B, and the object W is gripped in two portions thereof by the two sets of finger pairs A and B. As described above, in principle, the robot hand 100 of this embodiment grips an object W, even when the object W to be gripped is changed to another object, in the following manner. The finger pair B comes into contact with the object W before the finger pair A comes into contact with the object W, then the finger member 122b of the finger pair B is elastically deformed, and the finger pair A comes into contact with the object W.

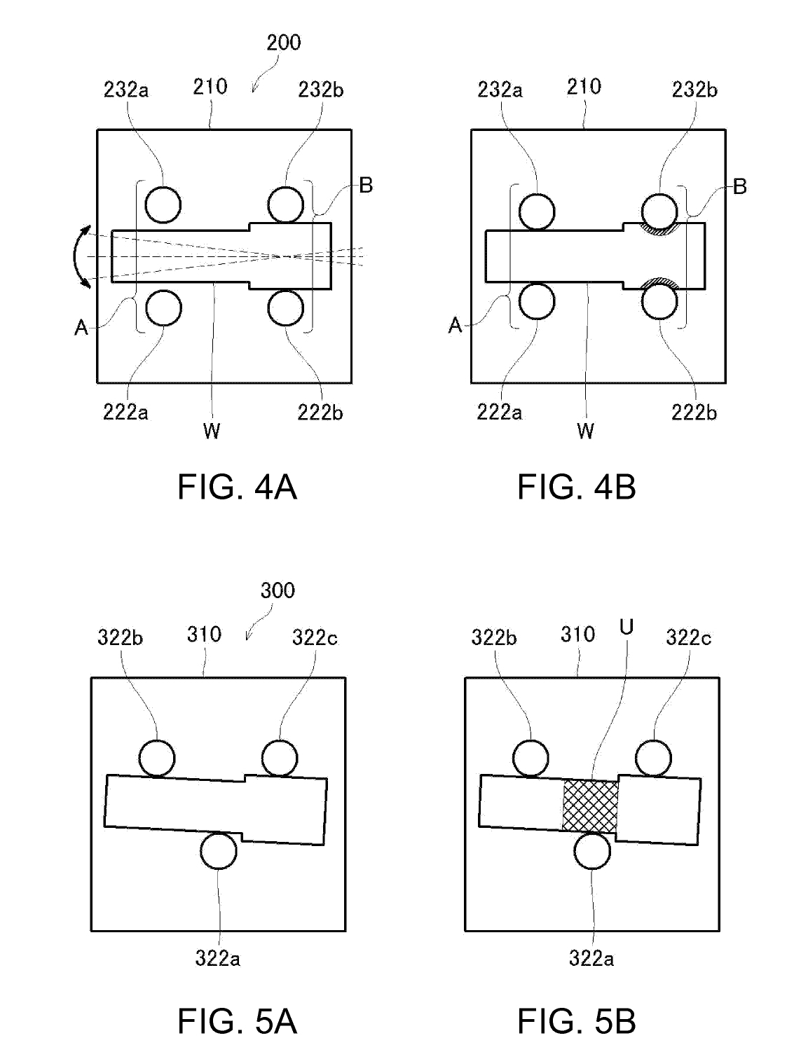

FIGS. 4A and 4B are explanatory diagrams showing, for reference sake, a state in which a robot hand having fingers made of metal grips an object W. In a robot hand 200 shown in the drawings, two sets of finger pairs (finger pairs A and B) are provided on a base 210, and all of four finger members (finger members 222a, 222b, 232a, and 232b) forming the finger pair A and the finger pair B are made of metal. Moreover, the two sets of finger pairs A and B can be moved closer to or away from the object W simultaneously by an unillustrated moving mechanism.

If the object W has a uniform thickness, such a robot hand 200 can grip the object W in two portions thereof as a result of the finger pair A and the finger pair B coming into contact with the object W simultaneously (which is not shown in the drawing). However, if the object W has a nonuniform thickness, as shown in FIG. 4A, the finger pair (in the drawing, the finger pair B) corresponding to a thicker portion of the object W comes into contact with the object W before the other finger pair (in the drawing, the finger pair A) comes into contact with the object W. In this state, the object W wobbles as indicated by a thick arrow in the drawing, making it difficult to grip the object W stably. If the space between the finger pair A and the space between the finger pair B are further reduced to grip the object W also with the finger pair A, the two finger members 222b and 232b of the finger pair B are pressed hard against the object W as shown in FIG. 4B, which may damage the object W.

On the other hand, the robot hand 100 of this embodiment can grip the object W with the two metal finger members (122a and 132a) of the finger pair A and at the same time press the object W against the metal finger member 132b of the finger pair B by means of the rubber finger member 122b of the finger pair B. As a result, the object W is positioned on the robot hand 100 in a predetermined position, making it possible to prevent the object W from wobbling.

Moreover, even when the robot hand 200 (see FIGS. 4A and 4B) having finger members made of metal grips an object W, it is possible to grip the object W with a nonuniform thickness in two portions thereof and prevent the object W from wobbling by, for example, allowing all the finger members to move independently and stopping the operation to reduce the space between the finger pair when the finger pair comes into contact with the object W. However, when a plurality of finger members are allowed to move independently as just described, the control of the robot hand 200 becomes complicated. On the other hand, the robot hand 100 of this embodiment can grip the object W with a nonuniform thickness only by moving the moving members 120 and 130 closer to the object W. This makes it possible to grip the object W with stability and at the same time prevent the control of the robot hand 100 from becoming complicated.

Incidentally, in the above description, the robot hand 100 of this embodiment prevents the object W from wobbling by pressing the object W against the finger member 132b by means of the rubber finger member 122b of the finger pair B. However, from the viewpoint of gripping the object W with stability, the object W can be gripped with stability also by the following robot hand. That is, as shown in FIGS. 5A and 5B, a three-fingered robot hand 300 in which two finger members (finger members 322b and 322c) and one finger member 322a facing the two finger members are provided on a base 310 grips the object W. In such a three-fingered robot hand 300, one finger member 322a is disposed in a position corresponding to a position between the two finger members 322b and 322c. As a result, as shown in FIG. 5A, it is possible to grip even an object W with a nonuniform thickness with stability by making the three finger members 322a, 322b, and 322c come into contact with the object W.

However, when the three-fingered robot hand 300 grips the object W as just described, the finger member 322a always comes into contact with a portion between the portions with which the two finger members 322b and 322c make contact. As a result, as shown in FIG. 5B, for example, when a breakable part (a part U) is placed in a portion between the two finger members 322b and 322c, for example, and contact with a portion corresponding to the part U is prohibited, it is impossible to grip the object W with the robot hand 300.

On the other hand, when the robot hand 100 of this embodiment grips the object W, the two sets of finger pairs A and B come into contact with the object W in two portions from the front and back sides of the object W. In general, even when the object W is an object having a portion which should not be touched, when the object W can be touched from the front side, in many cases, it is possible to touch the object W also from the back side. Therefore, by appropriately choosing portions of the object W in which the finger pair A and the finger pair B grip the object W, it is possible to grip the object W even when it is an object having a portion which should not be touched. This makes it possible to expand the range of objects W to which the robot hand 100 can be applied.

Incidentally, in the above description, when the robot hand 100 grips an object W with a nonuniform thickness, a thicker portion of the object W is gripped by the finger pair B (see FIGS. 3A and 3B). However, with the robot hand 100 of this embodiment, it is also possible to grip a thinner portion of the object W by the finger pair B as will be described below.

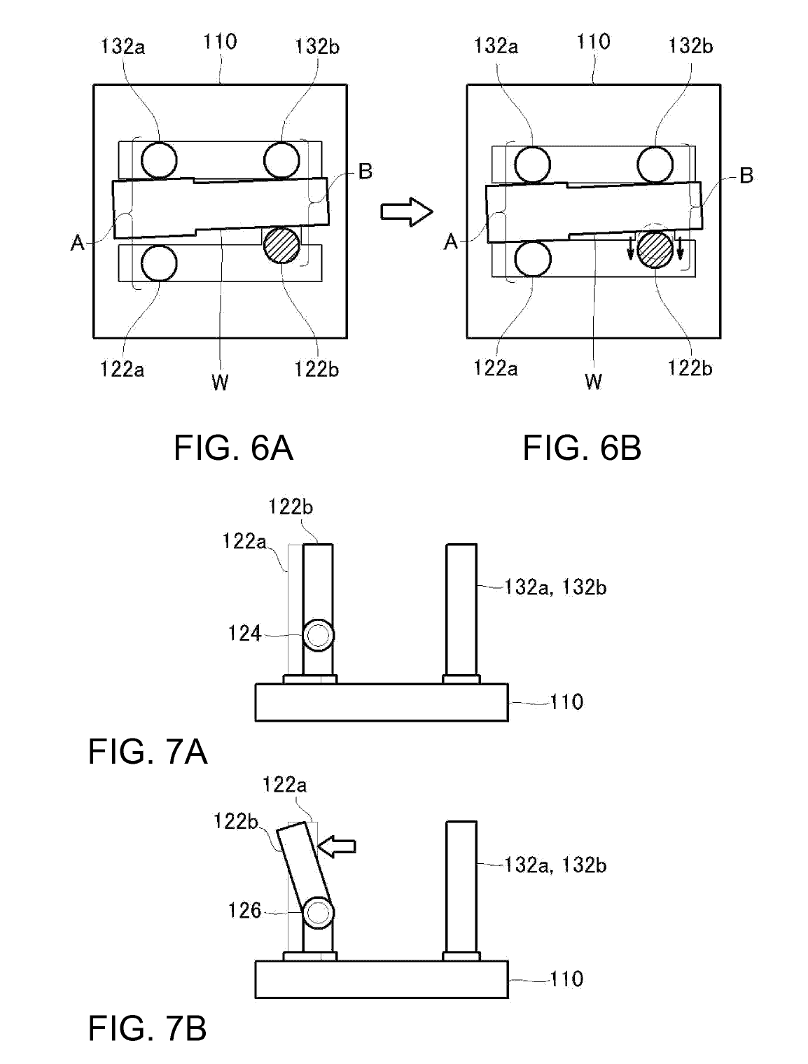

FIGS. 6A and 6B are explanatory diagrams showing a state in which, when the robot hand 100 of this embodiment grips an object W with a nonuniform thickness, a thinner portion of the object W is gripped by the finger pair B. When a thinner portion of the object W is gripped by the finger pair B, there is fear that the finger pair A comes into contact with the object W before the finger pair B comes into contact with the object W. However, in the robot hand 100 of this embodiment, the finger member 122b is provided in a position closer to the moving member 130 than the finger member 122a. Therefore, even when a portion to be gripped by the finger pair B is formed to be somewhat thin as shown in FIG. 6A, the finger pair B comes into contact with the object W before the finger pair A comes into contact with the object W. Thus, by further reducing the space between the finger pair B, it is possible to grip the object W stably by the two sets of finger pairs (the finger pairs A and B) as shown in FIG. 6B.

### C. Modified Examples

The embodiment described above can be modified in several ways. Hereinafter, such modified examples will be described briefly. It is to be noted that, in the modified examples described below, component elements which are similar to those of the embodiment described above are identified with the same reference characters, and their detailed explanations will be omitted.

### C-1. First Modified Example

In the robot hand 100 of the embodiment described above, the finger member 122b of the finger pair B is made of rubber. However, the finger member 122b simply has to be deformable by a force smaller than a force required to grip an object W. For example, the following finger member 122b may be used. It is to be noted that, in the modified example described below, component elements which are similar to those of the embodiment described above are identified with the same reference characters, and their detailed explanations will be omitted.

FIGS. 7A and 7B are explanatory diagrams showing the finger member 122b of the robot hand 100 of the modified example. In FIGS. 7A and 7B, a state in which the finger pair B of the robot hand 100 is viewed from the side of the robot hand 100 is shown.

The finger member 122b of the robot hand of the modified example shown in the drawing is made of metal. Moreover, a joint 126 is provided in the finger member 122b, and an unillustrated spring member is built into the joint 126. In the robot hand 100 of the modified example described above, when the finger member 122b experiences a force from the inside of the finger pair B, the finger member 122b is bent and deformed at a portion corresponding to the joint 126. Incidentally, some examples of the deformation of the finger member 122b are as follows. For example, as shown in FIGS. 7A and 7B, the finger member 122b may be deformed from a state in which the finger member 122b is made straight (a state shown in FIG. 7A) to a state in which the finger member 122b is bent to the outside of the finger pair B (a state shown in FIG. 7B), or the finger member 122b may be deformed from a state in which the finger member 122b is bent in advance to the inside of the finger pair B to a state in which the finger member 122b is made straight (which is not shown in the drawing). By using such a finger member 122b, as when the rubber finger member 122b described above is used, it is possible to grip various objects W stably with the two sets of finger pairs A and B. Moreover, by forming the finger member 122b by using metal possessing high stiffness, it is possible to increase the durability of the finger member 122b as compared to a case in which the finger member 122b is made of rubber.

### C-2. Second Modified Example

In the embodiment and first modified example described above, the finger member 122b provided on the moving member 120 is provided to be slightly closer to the moving member 130 than the finger member 122a provided on the same moving member 120. Here, the finger member 122b may be provided to be slightly closer to the side opposite to the moving member 130 than the finger member 122a.

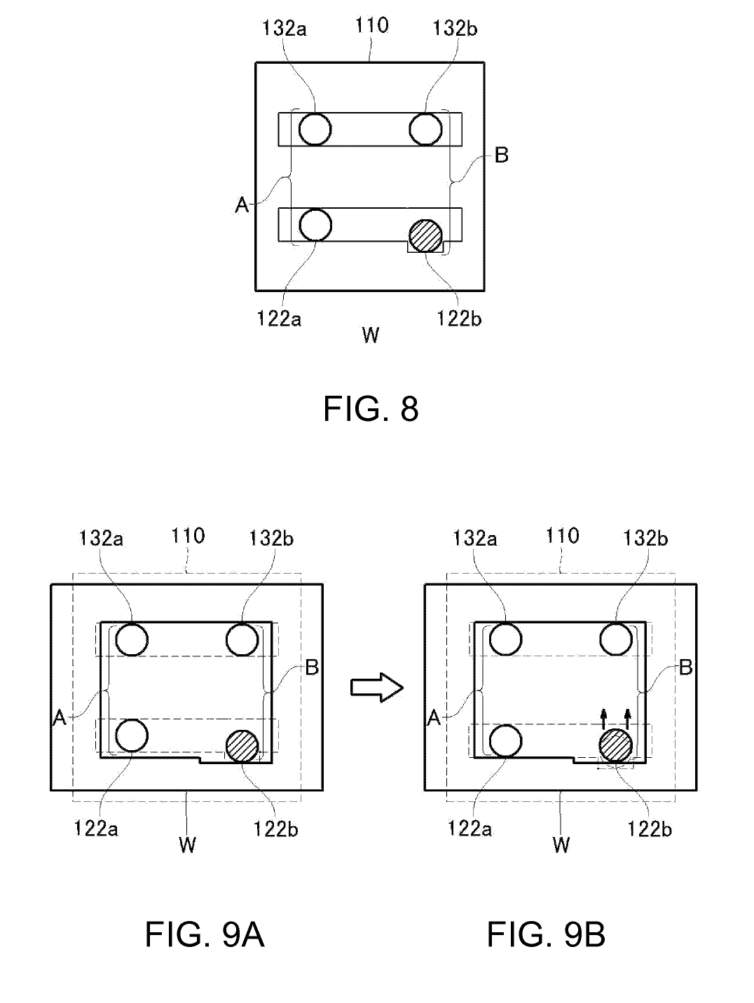

FIG. 8 is an explanatory diagram showing the structure of the robot hand 100 of a second modified example. In the robot hand 100 shown in the drawing, the finger member 122b is provided to be slightly closer to the side opposite to the moving member 130 than the finger member 122a. As a result, the space between the finger pair B is slightly larger than the space between the finger pair A.

FIGS. 9A and 9B are explanatory diagrams showing a state in which the robot hand 100 of the second modified example holds an object W. In FIGS. 9A and 9B, a state in which the robot hand 100 holds the object W having a large, virtually rectangular hole in the center thereof is shown. To hold such an object W, as shown in FIG. 9A, the finger pairs A and B are inserted into the hole, and then the space between the finger pair A and the space between the finger pair B are gradually widened. Since the space between the finger pair B is slightly larger than the space between the finger pair A, the finger pair B comes into contact with the inner periphery of the hole before the finger pair A comes into contact with the inner periphery of the hole (see FIG. 9A). Incidentally, FIGS. 9A and 9B show as an example a case in which the object W is held in which the area of the hole in a portion with which the finger pair B comes into contact is somewhat larger than the area of the hole in a portion with which the finger pair A comes into contact. However, it goes without saying that, even when the area of the hole in a portion with which the finger pair B comes into contact is equal to the area of the hole in a portion with which the finger pair A comes into contact or the area of the hole in a portion with which the finger pair B comes into contact is somewhat smaller than the area of the hole in a portion with which the finger pair A comes into contact, the finger pair B comes into contact with the inner periphery of the hole before the finger pair A comes into contact with the inner periphery of the hole in the same manner.

When the space between the finger pair A and the space between the finger pair B are further widened from a state in which the finger pair B makes contact with the inner periphery of the hole of the object W as just described, the rubber finger member 122b is deformed, and the finger pair A comes into contact with the inner periphery of the hole of the object W. As a result, it is possible to hold the object W stably by making the four fingers come into contact with the inner periphery of the hole of the object W. Moreover, when the object W is held in such a manner, the finger pairs A and B do not come into contact with the outer surface of the object W. This makes it possible to prevent the finger pairs A and B from making the outer surface of the object W dirty or damaging the outer surface of the object W by touching the outer surface.

While the robot hands of various embodiments have been described, the invention is not limited to the embodiment and modified examples described above and can be carried out in numerous ways without departing from the spirit of the invention. For example, in the robot hands of the embodiment and modified examples described above, two sets of finger members, each set being formed of two finger members provided on the same moving member, move closer to or away from an object in one direction. Instead, two sets of two finger members forming a pair may also move closer to or away from the object in a direction which is nearly perpendicular to the one direction described above.

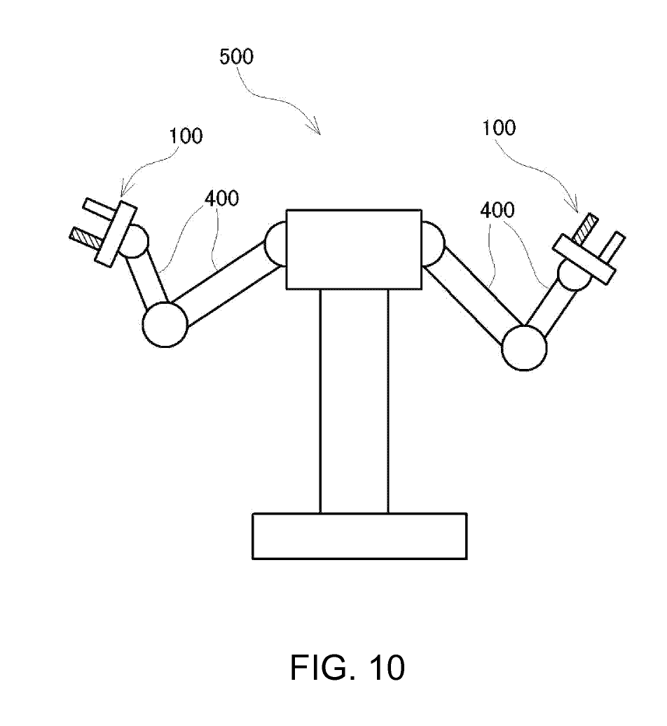

Moreover, the robot hands of the embodiment and modified examples which described above can grip various objects even though the robot hands have simple structures and are controlled with ease. Therefore, by creating a robot 500 by attaching these robot hands to the tips of robot arms 400 as shown in FIG. 10, it is possible to obtain the robot 500 that is highly versatile while having a simple structure and being controlled with ease.

The entire disclosure of Japanese Patent Application No. 2011-107932, filed May 13, 2011 is expressly incorporated by reference herein.

What is claimed is:

1. A robot hand gripping an object, comprising:
a base;
four fingers attached to the base; and
a finger driving unit driving the four fingers in such a way that the four fingers can move closer to or away from the object, wherein
one of the four fingers is a deformable finger that has a lower stiffness than the other three fingers of the four fingers, and
the deformable finger is attached to the base at a position other than at a center of the base.

2. The robot hand according to claim 1, wherein
the finger driving unit drives the four fingers in such a way that the four fingers move closer to or away from the object simultaneously at the same speed.

3. The robot hand according to claim 1, wherein
a space between two fingers including the deformable finger is set to be smaller than a space between the other two fingers of the four fingers.

4. The robot hand according to claim 1, wherein
a space between two fingers including the deformable finger is set to be larger than a space between the other two fingers of the four fingers.

5. A robot comprising the robot hand according to claim 1.

6. A robot comprising the robot hand according to claim 2.

7. A robot comprising the robot hand according to claim 3.

8. A robot comprising the robot hand according to claim 4.

9. The robot hand according to claim 1, wherein the deformable finger is made of an elastic material.

10. The robot hand according to claim 1, wherein the other three fingers are made of metal.

11. A robot comprising the robot hand according to claim 9.

12. A robot comprising the robot hand according to claim 10.
